(19) United States
(12) Patent Application Publication
(10) Pub. No.: US 2025/0370272 A1
(43) Pub. Date: Dec. 4, 2025

(54) OPTICAL MODULE

(71) Applicant: TDK TAIWAN CORP., Taoyuan City (TW)

(72) Inventors: Chao-Chang HU, Taoyuan City (TW); Yi-Ho CHEN, Taoyuan City (TW); Chia-Che WU, Taoyuan City (CN); Ya-Hsiu WU, Taoyuan City (TW)

(21) Appl. No.: 19/224,005

(22) Filed: May 30, 2025

Related U.S. Application Data
(60) Provisional application No. 63/654,266, filed on May 31, 2024.

(51) Int. Cl. G02B 27/64; G03B 5/00; G03B 13/36

(52) U.S. Cl. CPC G02B 27/646; G03B 5/00; G03B 13/36

(57) ABSTRACT

An optical module is provided, the optical module includes a fixed portion and a first optical assembly. The first optical assembly includes a first movable portion, a first driving assembly, and a guiding component. The first movable portion is movable relative to the fixed portion. The first driving assembly is configured to drive the first movable portion to move relative to the fixed portion. The guiding component guides the movement of the first movable portion relative to the fixed portion.

### CROSS REFERENCE TO RELATED APPLICATIONS

This application claims the benefit of U.S. Provisional Application No. 63/654,266, filed May 31, 2024, the entirety of which is incorporated by reference herein.

### BACKGROUND OF THE INVENTION

### Field of the Invention

The present invention relates to an optical module, and, in particular, to an optical module with a guiding component.

### Description of the Related Art

With advancements in technology, many modern electronic devices (e.g., smartphones) are now equipped with photography or video recording functions. The demand for such electronic devices continues to grow, and their designs are evolving toward being lighter, thinner, and higher in performance to provide users with more convenient and diverse options.

To enhance image quality and meet increasingly stringent spatial and performance requirements, some optical modules may include a plurality of optical assemblies, each performing different optical adjustment functions. For example, multiple optical assemblies may be arranged within the optical module, including an optical assembly with an auto-focus function that can move by being linearly guided by a guide rod. Through a combination of the aforementioned multiple optical assemblies, a wider range and more refined optical adjustment can be achieved, thereby further enhancing image quality. In addition, by using the guide rod to guide the movement of the auto-focus optical assembly, overall structural stability may also be improved, which in turn extends the service life and enhances the reliability and consistency of certain manufacturing processes.

### BRIEF SUMMARY OF THE INVENTION

An embodiment of the present invention provides an optical module. The optical module includes a fixed portion and a first optical assembly. The first optical assembly includes a first movable portion, a first driving assembly, and a guiding component. The first movable portion is movable relative to the fixed portion. The first driving assembly is configured to drive the first movable portion to move relative to the fixed portion. The guiding component guides the movement of the first movable portion relative to the fixed portion.

In some embodiments, the optical module has a first side and a second side opposite to each other, the first driving assembly of the first optical assembly is disposed on the first side, and the direction from the first side to the second side is perpendicular to the direction in which the guiding component extends.

### BRIEF DESCRIPTION OF THE DRAWINGS

The following will be described in detail with reference to the accompanying drawings. It should be noted that, in accordance with standard practice in the industry, various features are not drawn to scale and are only used for illustration purposes. In fact, the size of the components may be arbitrarily enlarged or reduced to clearly show the features of the present disclosure.

FIG. 1 shows a perspective view of an optical module according to some embodiments of the present disclosure.

FIG. 2 shows an exploded view of the optical module according to some embodiments of the present disclosure.

FIG. 3 shows a perspective view of the optical module according to some embodiments of the present disclosure, wherein a housing and a first movable portion are not shown for illustrative purposes.

FIG. 4 shows a cross-sectional view of the optical module taken along line A-A′ of FIG. 1.

FIG. 5 is a perspective view of the optical module according to some embodiments of the present disclosure, wherein the housing is not shown for illustrative purposes.

FIG. 6 shows an exploded view of a first base and an intermediate member according to some embodiments of the present disclosure.

FIG. 7 shows a perspective view of a portion of the optical module according to some embodiments of the present disclosure.

FIG. 8 shows a cross-sectional view of the optical module taken along line B-B′ of FIG. 1.

FIG. 9 shows a perspective view of the first movable portion, a first magnetic component and a stabilizing component of the first optical assembly.

### DETAILED DESCRIPTION OF THE INVENTION

Unless otherwise defined, all terms, including technical and scientific terms, used herein have the same meanings as commonly understood by one of ordinary skill in the art. It is understood that these terms, such as those defined in commonly used dictionaries, should be interpreted as having a meaning consistent with the background or context of the relevant technology and the present disclosure, and should not be interpreted in an idealized or overly formal manner unless specifically defined herein.

Furthermore, ordinal terms such as “first,” “second,” and the like used in the specification and claims to modify components of the claims do not, by themselves, indicate any chronological order of the claimed components, nor do they imply any order between components or in the manufacturing process. The use of such ordinal terms is merely for the purpose of clearly distinguishing one component having a given name from another component having the same name.

In addition, in some embodiments of the present disclosure, terms such as “connection”, “interconnection”, etc., unless otherwise defined, may refer to two structures being in direct contact, or may refer to two structures not being in direct contact, with another structure disposed between the two structures. Such terms may also include situations where both structures are movable, or both structures are fixed.

In the description of the present specification, the description with reference to the terms “one embodiment”, “some embodiments”, “example”, etc. means that the specific features, structures, materials or characteristics described in conjunction with the embodiment or example are included in at least one embodiment or example of the present disclosure. In the present specification, the schematic representations of the above terms do not necessarily refer to the same embodiment or example. Moreover, the specific features, structures, materials or characteristics described may be combined in any one or more embodiments or examples in a suitable manner. In addition, a person having ordinary skill in the art may combine different embodiments or examples described in the present specification.

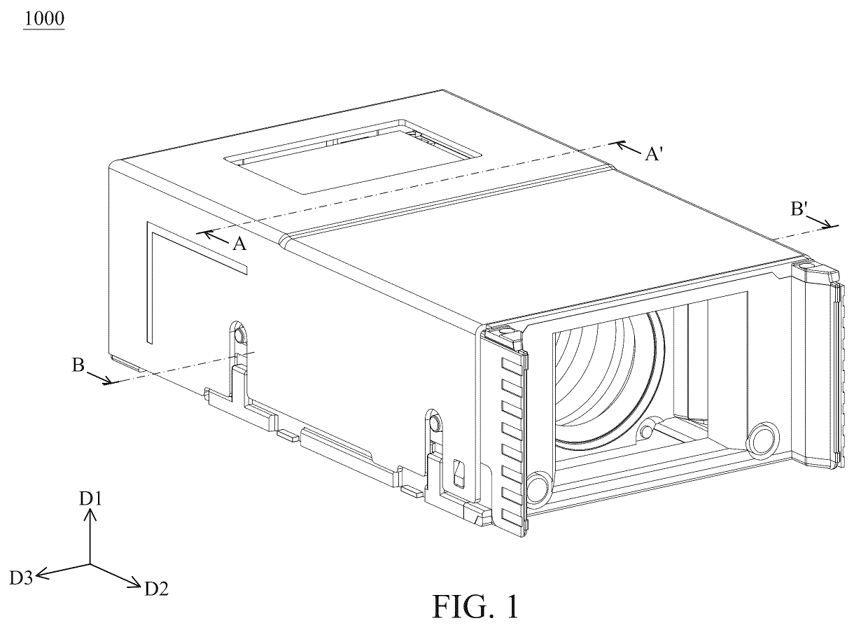

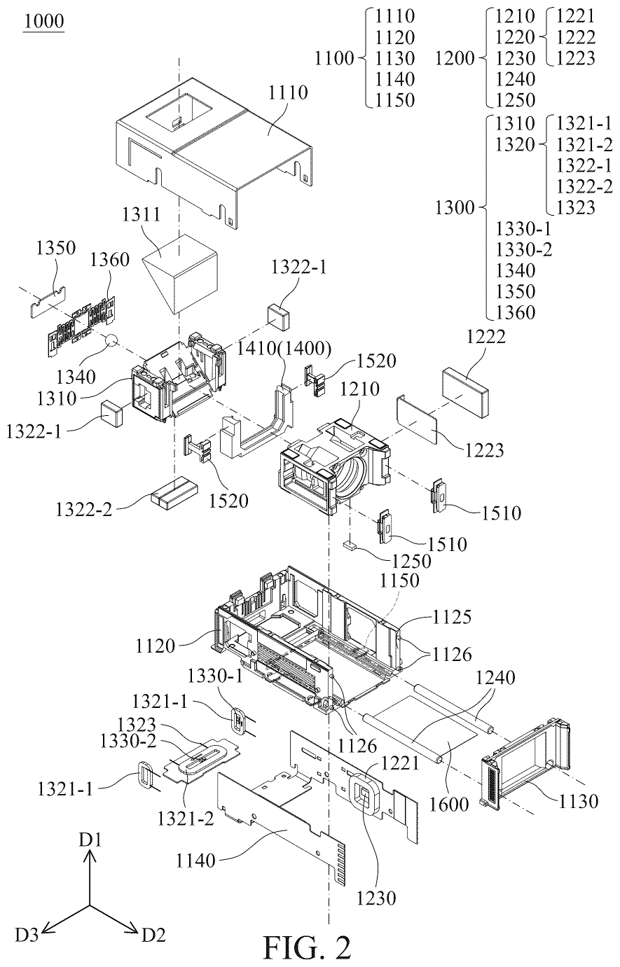

FIG. 1 shows a perspective view of an optical module 1000 according to some embodiments of the present disclosure. FIG. 2 shows an exploded view of the optical module 1000 according to some embodiments of the present disclosure. The overall structure of the optical module 1000 will be described in detail below, with reference to FIG. 1 and FIG. 2.

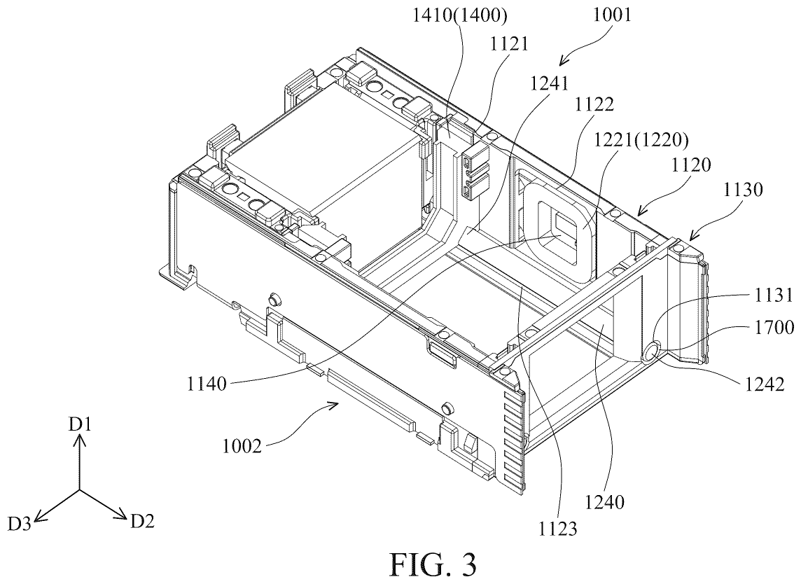

According to some embodiments of the present disclosure, the optical module 1000 includes a fixed portion 1100, a first optical assembly 1200, a second optical assembly 1300, a third optical assembly 1400, two buffer components 1510, two buffer components 1520, a stray light suppression component 1600 and a plurality of adhesive components 1700 (FIG. 3).

According to some embodiments of the present disclosure, the fixed portion 1100 includes a housing 1110, a first base 1120, a second base 1130, a circuit member 1140 and an intermediate member 1150.

According to some embodiments of the present disclosure, the housing 1110, the first base 1120, and the second base 1130 of the fixed portion 1100 are connected together to form an accommodating space for accommodating other components of the optical module 1000.

According to some embodiments of the present disclosure, the circuit member 1140 of the fixed portion 1100 is disposed on the first base 1120. The intermediate member 1150 of the fixed portion 1100 is partially embedded in the first base 1120.

According to some embodiments of the present disclosure, the first optical assembly 1200 may be an optical assembly for performing auto-focusing. The first optical assembly 1200 includes a first movable portion 1210, a first driving assembly 1220, a sensing component 1230, a pair of guiding components 1240 and a stabilizing component 1250.

According to some embodiments of the present disclosure, the first movable portion 1210 of the first optical assembly 1200 is movable relative to the fixed portion 1100. The first movable portion 1210 carries an optical component (not shown). The first driving assembly 1220 is configured to drive the first movable portion 1210 to move relative to the fixed portion 1100 to achieve a desired optical effect.

According to some embodiments of the present disclosure, the first driving assembly 1220 includes a first coil 1221, a first magnetic component 1222, and a first magnetically permeable component 1223. The first coil 1221 is disposed on the circuit member 1140 of the fixed portion 1100 and is electrically connected to the circuit member 1140. The first magnetic component 1222 and the first magnetically permeable component 1223 are disposed on the first movable portion 1210.

In this way, when a drive signal is applied to the first driving assembly 1220 (for example, by supplying current from an external power source), an electromagnetic inductive force is generated between the first magnetic component 1222 and the first coil 1221, thereby driving the first movable portion 1210 to move relative to the fixed portion 1100 along the second axis D2 to achieve the desired optical effect. In addition, the configuration of the first magnetically permeable component 1223 allows the magnetic force of the first driving assembly 1220 to be concentrated, thereby achieving improved driving performance.

According to some embodiments of the present disclosure, the sensing component 1230 of the first optical assembly 1200 is disposed on the circuit member 1140 and is positioned at the center of the annular structure of the first coil 1221. The sensing component 1230 corresponds to the first magnetic component 1222, that is, the sensing component 1230 may detect changes in the magnetic field of the first magnetic component 1222 and thereby determine the position of the first movable portion 1210 relative to the fixed portion 1100.

According to some embodiments of the present disclosure, the guiding component 1240 of the first optical assembly 1200 may be a guide rod. The guiding component 1240 of the first optical assembly 1200 guides the movement of the first movable portion 1210 relative to the fixed portion 1100. The guiding component 1240 is disposed on the first base 1120.

According to some embodiments of the present disclosure, the stabilizing component 1250 of the first optical assembly 1200 is a magnetic component. The stabilizing component 1250 is disposed on a side of the first movable portion 1210 that is facing the intermediate member 1150 of the fixed portion 1100.

According to some embodiments of the present disclosure, a magnetic attraction exists between the stabilizing component 1250 and the intermediate member 1150, or between the stabilizing component 1250 and the guiding component 1240. In this way, the first movable portion 1210 may be magnetically attracted toward the intermediate member 1150 or the guiding component 1240, thereby ensuring smoother movement of the first movable portion 1210 relative to the fixed portion 1100 and preventing the first movable portion 1210 from overturning during movement.

According to some embodiments of the present disclosure, the second optical assembly 1300 may be an optical assembly for performing optical image stabilization. The second optical assembly 1300 includes a second movable portion 1310, an optical path deflecting component 1311, a second driving assembly 1320, a sensing component 1330-1, a sensing component 1330-2, a support component 1340, a corresponding member 1350, and an elastic component 1360.

According to some embodiments of the present disclosure, the second movable portion 1310 carries the optical path deflecting component 1311. The second movable portion 1310 is movable relative to the fixed portion 1100. The optical path deflecting component 1311 may be a prism. The optical path deflecting component 1311 deflects light propagating along the negative direction of a first axis D1, such that the light exits along the positive direction of a second axis D2. The first axis D1 is perpendicular to the second axis D2. The first axis D1 and the second axis D2 are respectively perpendicular to a third axis D3.

According to some embodiments of the present disclosure, the second driving assembly 1320 is configured to drive the second movable portion 1310 to move relative to the fixed portion 1100. The second driving assembly 1320 includes two second coils 1321-1, a second coil 1321-2, two second magnetic components 1322-1, a second magnetic component 1322-2 and a second magnetically permeable component 1323.

According to some embodiments of the present disclosure, two second coils 1321-1 are aligned along the third axis D3 and are respectively disposed on the circuit member 1140. Two second magnetic components 1322-1 are aligned along the third axis D3 and are disposed on opposite sides of the second movable portion 1310.

In this way, when a drive signal is applied to the second driving assembly 1320 (for example, by supplying current from an external power source), an electromagnetic inductive force is generated between the corresponding second coil 1321-1 and second magnetic component 1322-1, thereby driving the second movable portion 1310 to move relative to the fixed portion 1100 by rotating about a rotation axis, which is parallel to the first axis D1, with the support component 1340 serving as a pivot, to achieve the desired optical effect.

According to some embodiments of the present disclosure, the sensing component 1330-1 is disposed on the circuit component 1140 and positioned at the center of the annular structure of one of the two second coils 1321-1. The sensing component 1330-1 corresponds to the second magnetic component 1322-1. In other words, the sensing component 1330-1 may detect changes in the magnetic field of the second magnetic component 1322-1 and thereby determine the position of the second movable portion 1310 relative to the fixed portion 1100.

According to some embodiments of the present disclosure, the orientation of the second coil 1321-2 is perpendicular to that of the second coil 1321-1, and the second coil 1321-2 and the second magnetically permeable component 1323 are disposed on the circuit component 1140. The second magnetic component 1322-2 is disposed on the side of the second movable portion 1310 that is opposite to the optical path deflecting component 1311.

In this way, when a drive signal is applied to the second driving assembly 1320 (for example, by supplying current from an external power source), an electromagnetic inductive force is generated between the corresponding second coil 1321-2 and the second magnetic component 1322-2, thereby driving the second movable portion 1310 to rotate relative to the fixed portion 1100 about a rotation axis parallel to the third axis D3, with the support component 1340 serving as a pivot, to achieve the desired optical effect.

According to some embodiments of the present disclosure, the sensing component 1330-2 is disposed on the circuit component 1140 and positioned at the center of the annular structure of the second coil 1321-2. The sensing component 1330-2 corresponds to the second magnetic component 1322-2. In other words, the sensing component 1330-2 may detect changes in the magnetic field of the second magnetic component 1322-2 and thereby determine the position of the second movable portion 1310 relative to the fixed portion 1100.

According to some embodiments of the present disclosure, the support component 1340 is disposed on the second movable portion 1310 and has a spherical shape. The corresponding member 1350 is disposed on the first base 1120 and has a plate-like shape. The support component 1340 and the corresponding member 1350 are in contact, forming a pivot point for the movement of the second movable portion 1310 relative to the fixed portion 1100.

According to some embodiments of the present disclosure, the elastic component 1360 is elastic. The elastic component 1360 is connected to the first base 1120 and the second movable portion 1310. The elastic component 1360 may provide elastic supporting force to the second movable portion 1310, thereby limiting its range of movement relative to the first base 1120, or returning it to a predetermined position after displacement.

According to some embodiments of the present disclosure, the third optical assembly 1400 is an optical assembly disposed between the first optical assembly 1200 and the second optical assembly 1300. The second optical assembly 1300, the third optical assembly 1400 and the first optical assembly 1200 are sequentially arranged along the direction of the second axis D2. The third optical assembly 1400 includes a holding member 1410. The holding member 1410 carries an optical component (not shown) to enhance the optical performance of the optical module 1000.

According to some embodiments of the present disclosure, the buffer component 1510 is disposed on the second base 1130 to absorb the impact force generated when the first movable portion 1210 moves to a limit position. The buffer component 1520 is disposed between the first base 1120 and the holding member 1410 of the third optical assembly 1400 to absorb the impact force generated when the first movable portion 1210 moves to another limit position.

According to some embodiments of the present disclosure, the stray light suppression component 1600 is disposed on the first base 1120 to prevent stray light, generated after light sequentially enters the second optical assembly 1300, the third optical assembly 1400 and the first optical assembly 1200, from further entering the image sensor (not shown) disposed on the second base 1130.

FIG. 3 shows a perspective view of the optical module 1000 according to some embodiments of the present disclosure, wherein for illustration purposes, the housing 1110 and the first movable portion 1210 are not shown. As shown in FIG. 3, the first base 1120 includes a protrusion 1121, a hollow portion 1122 and a pair of holding portions 1123.

According to some embodiments of the present disclosure, the third optical assembly 1400 abuts against the protrusion 1121 of the first base 1120 to limit the movement of the third optical assembly 1400 along the direction of the second axis D2.

According to some embodiments of the present disclosure, the optical module 1000 has a first side 1001 and a second side 1002 that are opposite to each other. The direction from the first side 1001 to the second side 1002 is perpendicular to the extending direction of the guiding component 1240. The first driving assembly 1220 of the first optical assembly 1200 is disposed on the first side 1001 of the optical module 1000.

As shown in FIG. 3, the hollow portion 1122 of the first base 1120 is located on the first side 1001 of the optical module 1000. The first coil 1221, which is disposed on the circuit component 1140, passes through the hollow portion 1122 of the first base 1120, thereby reducing the thickness of the optical module 1000 in the direction of the third axis D3. As also shown in FIG. 3, the guiding component 1240 is disposed on the holding portion 1123 of the first base 1120.

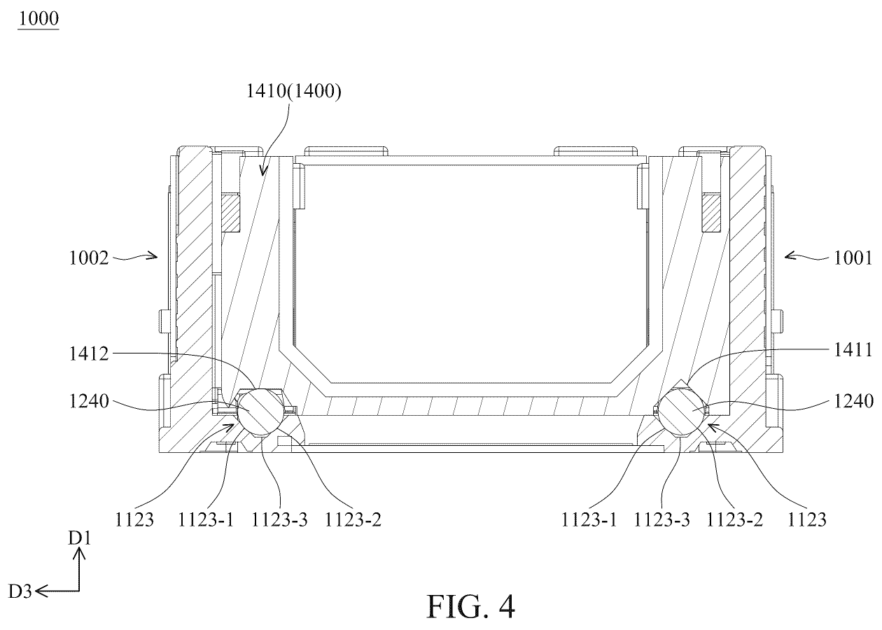

FIG. 4 shows a cross-sectional view of the optical module 1000 taken along line A-A′ of FIG. 1. As shown in FIG. 4, the holding portion 1123 that carries the guiding component 1240 includes a first surface 1123-1, a second surface 1123-2, and a third surface 1123-3. The third surface 1123-3 is located between the first surface 1123-1 and the second surface 1123-2.

According to some embodiments of the present disclosure, the guiding component 1240 contacts the first surface 1123-1 and the second surface 1123-2 of the holding portion 1123, and the guiding component 1240 does not contact the third surface 1123-3. The angle formed between the first surface 1123-1 and the third surface 1123-3 is equal to the angle formed between the second surface 1123-2 and the third surface 1123-3. When viewed along the second axis D2, the holding portion 1123 may be a trapezoidal groove.

According to some embodiments of the present disclosure, the holding member 1410 of the third optical assembly 1400 includes a first contact portion 1411 and a second contact portion 1412. The first contact portion 1411 and the second contact portion 1412 respectively press against the guiding component 1240. Specifically, the first contact portion 1411 and the second contact portion 1412 contact the guiding component 1240 to limit the movement of the guiding component 1240 along the first axis D1.

According to some embodiments of the present disclosure, the first contact portion 1411 is a V-shaped groove that is in contact with the guiding component 1240. When viewed from the direction of the second axis D2, there are two contact points between the first contact portion 1411 and the guiding component 1240. The second contact portion 1412 is a U-shaped groove that is in contact with the guiding component 1240, and when viewed from the direction of the second axis D2, there is one contact point between the second contact portion 1412 and the guiding component 1240.

According to some embodiments of the present disclosure, the V-shaped groove (first contact portion 1411) is located near the first side 1001 of the optical module 1000 (which is adjacent to the first driving assembly 1220 shown in FIG. 2), and the U-shaped groove (second contact portion 1412) is located near the second side 1002 of the optical module 1000. This results in better alignment and clamping stability, thereby improving the overall assembly precision of the optical module and ensuring consistent optical adjustment.

Referring back to FIG. 3, as shown in FIG. 3, the guiding component 1240 includes a first end 1241 and a second end 1242 that are opposite to each other. The first end 1241 of the guiding component 1240 is positioned between the holding member 1410 of the third optical assembly 1400 and the holding portion 1123 of the first base 1120.

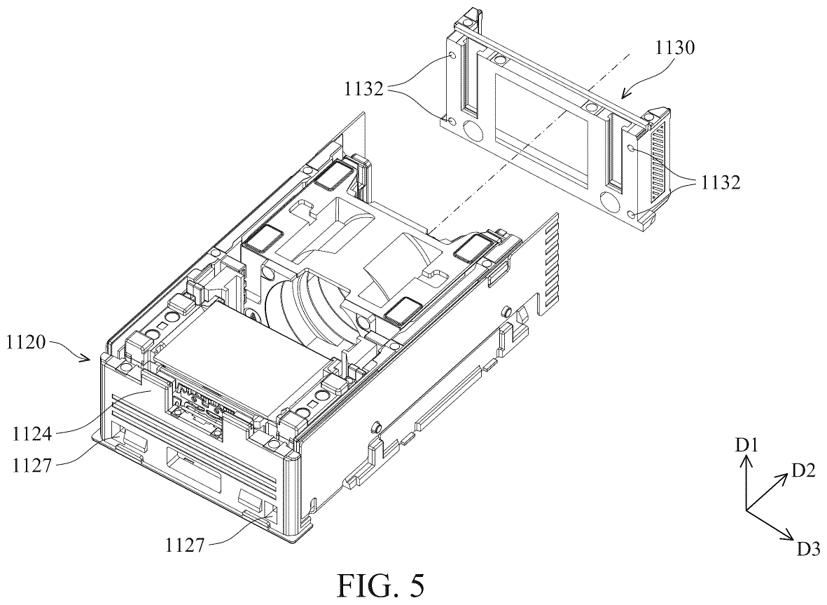

According to some embodiments of the present disclosure, the second base 1130 includes a pair of insertion holes 1131 (FIG. 3) and four positioning holes 1132 (FIG. 5). The second end 1242 of the guiding component 1240 (FIG. 3) passes through the insertion hole 1131 of the second base 1130, and the insertion hole 1131 is filled with an adhesive component 1700 to affix the second end 1242 of the guiding component 1240.

FIG. 5 shows a perspective view of the optical module 1000 according to some embodiments of the present disclosure, wherein the housing 1110 is not shown for illustrative purposes. Referring to FIG. 2 and FIG. 5, the first base 1120 further includes a first surface 1124 (FIG. 5) and a second surface 1125 (FIG. 2) facing opposite directions. The first base 1120 further includes four positioning columns 1126 (FIG. 2). As shown in FIG. 5, the first surface 1124 includes two openings 1127.

According to some embodiments of the present disclosure, the direction from the first surface 1124 (FIG. 5) to the second surface 1125 (FIG. 2) is parallel to the second axis D2. As shown in FIG. 2, the positioning column 1126 of the first base 1120 is located on the second surface 1125. The positioning column 1126 protrudes from the second surface 1125 along the direction of the second axis D2.

According to some embodiments of the present disclosure, the positioning column 1126 (FIG. 2) of the first base 1120 passes through the positioning hole 1132 (FIG. 5) of the second base 1130, so that the second base 1130 is connected to the second surface 1125 (FIG. 2) of the first base 1120. The second base 1130 is connected to an image sensor (not shown).

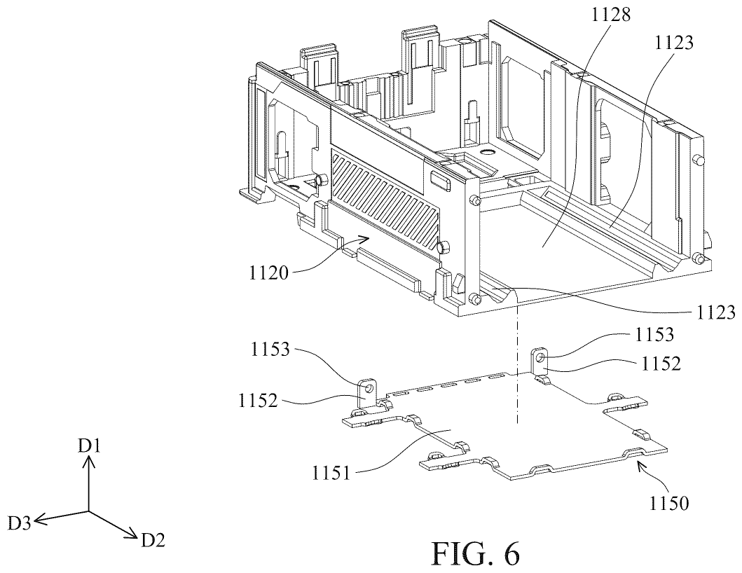

FIG. 6 shows an exploded view of the first base 1120 and the intermediate member 1150 according to some embodiments of the present disclosure. As shown in FIG. 6, the first base 1120 further includes a middle portion 1128, and the middle portion 1128 is located between the two holding portions 1123.

According to some embodiments of the present disclosure, the intermediate member 1150 includes a flat portion 1151 and two connecting portions 1152. The flat portion 1151 of the intermediate member 1150 is embedded in the middle portion 1128 of the first base 1120. The connecting portions 1152 of the intermediate member 1150 are perpendicular to the flat portion 1151. Each connecting portion 1152 of the intermediate member 1150 includes a connecting opening 1153.

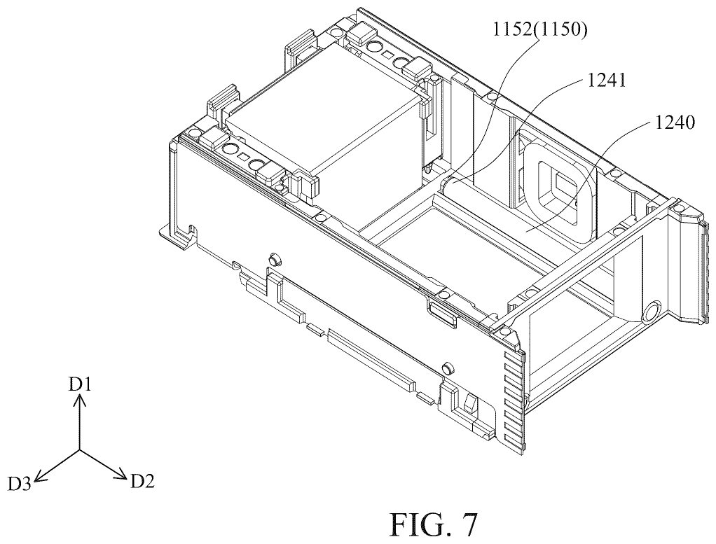

FIG. 7 shows a perspective view of a portion of the optical module 1000 according to some embodiments of the present disclosure. The first end 1241 of the guiding component 1240 is connected to the connecting portion 1152 of the intermediate member 1150 via welding. The connecting opening 1153 (FIG. 6) may have a circular shape to increase the bonding area and improve the connection stability.

Please refer to FIG. 5 to FIG. 7. The opening 1127 of the first surface 1124 of the first base 1120 (FIG. 5), the connecting opening 1153 of the connecting portion 1152 of the intermediate member 1150 (FIG. 6), and the first end 1241 of the guiding component 1240 (FIG. 7) are aligned in sequence along the second axis D2.

According to some embodiments of the present disclosure, when viewed along the second axis D2, the opening 1127 and the connecting portion 1152 at least partially overlap, and the opening 1127 and the connecting opening 1153 at least partially overlap, whereby, during the assembly of the optical module 1000, the connecting opening 1153 (FIG. 6) of the connecting portion 1152 of the intermediate member 1150 and the first end 1241 (FIG. 7) of the guiding component 1240 are connected together by welding through the opening 1127 (FIG. 5) of the first surface 1124 of the first base 1120.

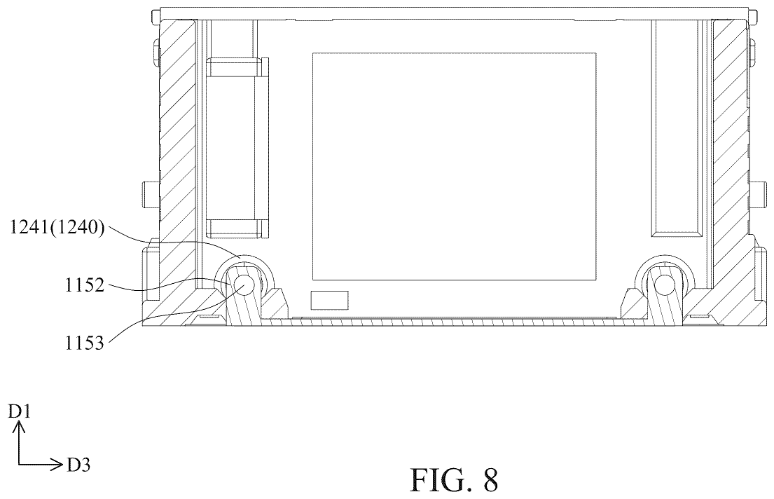

FIG. 8 shows a cross-sectional view of the optical module 1000 taken along line B-B′ of FIG. 1. As shown in FIG. 8, when viewed along the second axis D2, the height between the connecting portion 1152 and the flat portion 1151 along the first axis D1 does not exceed the height between the guiding component 1240 and the flat portion 1151 along the first axis D1.

In this way, the holding member 1410 of the third optical assembly 1400 (FIG. 3) can press against the first end 1241 of the guiding component 1240 without being prevented from providing a limiting function due to the shape of the connecting portion 1152 protruding beyond the guiding component 1240 along the first axis D1.

As shown in FIG. 8, when viewed along the second axis D2, the width of the connecting portion 1152 along the third axis D3 does not exceed the width of the guiding component 1240 along the third axis D3. In this way, the holding member 1410 of the third optical assembly 1400 (FIG. 3) can press against the first end 1241 of the guiding component 1240 without being prevented from providing a limiting function due to the shape of the connecting portion 1152 protruding beyond the guiding component 1240 along the third axis D3.

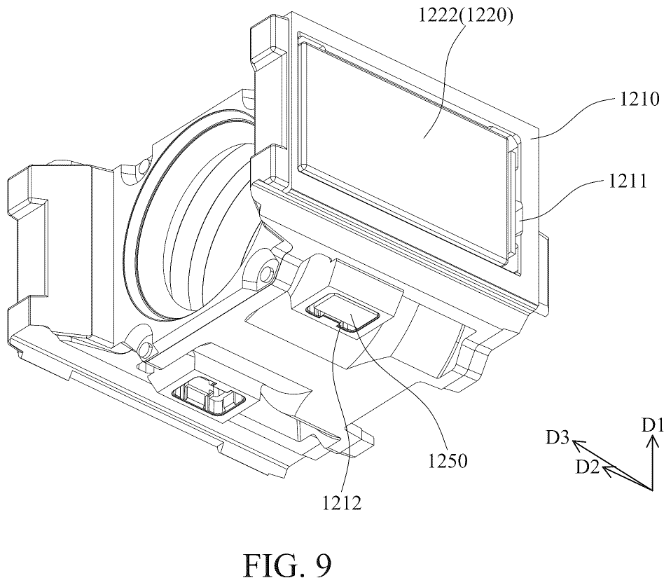

FIG. 9 shows a perspective view of the first movable portion 1210, the first magnetic component 1222, and the stabilizing component 1250 of the first optical assembly 1200. As shown in FIG. 9, the first movable portion 1210 includes a receiving space 1211 and a groove 1212.

According to some embodiments of the present disclosure, the receiving space 1211 of the first movable portion 1210 receives the first magnetic component 1222 of the first driving assembly 1220. In this way, component layout can be effectively integrated, reducing the module thickness and thereby achieving a compact design of the optical module 1000.

According to some embodiments of the present disclosure, the groove 1212 of the first movable portion 1210 accommodates the stabilizing component 1250. At least one of the intermediate member 1150 or the guiding component 1240 includes a metal material, so that there is a magnetic attraction between the stabilizing component 1250 and the flat portion 1151 of the intermediate member 1150 (FIG. 6), or there is a magnetic attraction between the stabilizing component 1250 and the guiding component 1240 (FIG. 7).

In this way, the first movable portion 1210 can be attracted toward the flat portion 1151 of the intermediate member 1150 (FIG. 6) or toward the guiding component 1240 (FIG. 7), thereby ensuring smoother movement of the first movable portion 1210 relative to the fixed portion 1100 and preventing the first movable portion 1210 from overturning during movement.

In summary, the connecting portion of the intermediate member can be fixed to one end of the guiding component by laser welding, thereby ensuring bonding strength and enhancing process consistency. A stabilizing component is provided on the first movable portion, and a magnetic attraction is generated between the stabilizing component and the flat portion of the intermediate member, thereby facilitating smooth movement of the first movable portion and effectively suppressing overturning of the first movable portion. In addition, the flat portion of the intermediate member also helps reinforce the structural strength of the fixed portion, further enhancing the overall mechanical stability of the module.

In terms of the optical path, light may sequentially pass through the second optical assembly, the third optical assembly, and the first optical assembly, and then form an image on an image sensor disposed on the second base. To meet process requirements, an opening is provided on the first base near the position of the second optical assembly (i.e., the position opposite to the second base), allowing the laser welding beam to accurately irradiate the connecting portion of the intermediate member and the guiding component through the opening. This improves the precision and efficiency of the welding process, thereby enhancing the structural reliability of the finished product and the overall yield.

In addition, to more precisely limit the guiding component, the holding member of the third optical assembly is provided with a V-shaped groove and a U-shaped groove, wherein the V-shaped groove is located on the first side adjacent to the first driving assembly. This design enables improved alignment and clamping stability, thereby further enhancing the overall assembly precision of the optical module and the consistency of optical adjustment.

Although the embodiments and advantages of the present disclosure have been disclosed as above, it should be understood that any person with ordinary knowledge in the art can make changes, substitutions and modifications without departing from the spirit and scope of the present disclosure. In addition, the scope of protection of the present disclosure is not limited to the processes, machines, manufacturing, material compositions, devices, methods and steps in the specific embodiments described in the specification. Any person with ordinary knowledge in the art can understand the current or future developed processes, machines, manufacturing, material compositions, devices, methods and steps from the disclosure content of the present disclosure, as long as they can implement substantially the same functions or obtain substantially the same results in the embodiments described herein, they can be used according to the present disclosure. Therefore, the scope of protection of the present disclosure includes the above-mentioned processes, machines, manufacturing, material compositions, devices, methods and steps. In addition, each claim constitutes a separate embodiment, and the scope of protection of the present disclosure also includes the combination of each claim and the embodiment.

What is claimed is:

1. An optical module, comprising:
a fixed portion; and
a first optical assembly, comprising:
a first movable portion, movable relative to the fixed portion;
a first driving assembly, for driving the first movable portion to move relative to the fixed portion; and
a guiding component guiding the movement of the first movable portion relative to the fixed portion.

2. The optical module as claimed in claim 1, wherein the optical module has a first side and a second side opposite to each other, the first driving assembly of the first optical assembly is disposed on the first side, and a direction from the first side to the second side is perpendicular to a direction in which the guiding component extends.

3. The optical module as claimed in claim 2, further comprising a second optical assembly, wherein the second optical assembly comprises:
an optical path deflecting component configured to deflect light propagating along a first axis such that the light exits along a second axis;
a second movable portion, carrying the optical path deflecting component and being movable relative to the fixed portion; and
a second driving assembly, configured to drive the second movable portion to move relative to the fixed portion.

4. The optical module as claimed in claim 3, further comprising a third optical assembly, wherein the third optical assembly comprises a holding member, the holding member comprises a first contact portion and a second contact portion, and the first contact portion and the second contact portion contact the guiding component to limit movement of the guiding component along the first axis direction.

5. The optical module as claimed in claim 4, wherein the first contact portion is a V-shaped groove in contact with the guiding component.

6. The optical module as claimed in claim 5, wherein the second contact portion is a U-shaped groove in contact with the guiding component.

7. The optical module as claimed in claim 6, wherein the V-shaped groove is located near the first side of the optical module, and the U-shaped groove is located near the second side of the optical module.

8. The optical module as claimed in claim 4, wherein the fixed portion comprises a first base and a second base, the first base comprises a first surface and a second surface facing in opposite directions, and a direction from the first surface to the second surface is parallel to the second axis.

9. The optical module as claimed in claim 8, wherein the first base comprises a positioning column located on the second surface, the second base comprises a positioning hole, and the positioning column of the first base passes through the positioning hole of the second base so that the second base is connected to the second surface of the first base.

10. The optical module as claimed in claim 8, wherein the second base is connected to an image sensor.

11. The optical module as claimed in claim 8, wherein the first base comprises a protrusion, and the third optical assembly abuts against the protrusion to limit movement of the third optical assembly along the second axis.

12. The optical module as claimed in claim 8, wherein the fixed portion further comprises an intermediate member, the intermediate member comprises a flat portion and a connecting portion, the flat portion is embedded in the first base, and the connecting portion is perpendicular to the flat portion.

13. The optical module as claimed in claim 12, wherein the connecting portion comprises a connecting opening, the first surface of the first base comprises an opening, the guiding component comprises a first end and a second end, the second base comprises an insertion hole, the first end of the guiding component is connected to the connecting portion of the intermediate member by welding, and the second end of the guiding component passes through the insertion hole of the second base.

14. The optical module as claimed in claim 13, wherein the insertion hole is filled with an adhesive component to affix the second end of the guiding component.

15. The optical module as claimed in claim 13, wherein the opening on the first surface of the first base, the connecting opening of the connecting portion, and the first end of the guiding component are sequentially aligned along the second axis.

16. The optical module as claimed in claim 13, wherein during assembly of the optical module, the connecting opening of the connecting portion of the intermediate member is welded to the first end of the guiding component through the opening on the first surface of the first base.

17. The optical module as claimed in claim 13, wherein when viewed along the second axis, a height of the connecting portion along the first axis does not exceed a height of the guiding component along the first axis.

18. The optical module as claimed in claim 13, wherein when viewed along the second axis, a width of the connecting portion along a third axis does not exceed a width of the guiding component along the third axis, and the third axis is perpendicular to the first axis, and the third axis is perpendicular to the second axis.

19. The optical module as claimed in claim 13, wherein the first optical assembly further comprises a stabilizing component, the stabilizing component is disposed on the first movable portion, and there is a magnetic attraction between the stabilizing component and the flat portion of the intermediate member, or there is a magnetic attraction between the stabilizing component and the guiding component.

20. The optical module as claimed in claim 13, wherein the first base comprises a holding portion, the guiding component is disposed on the holding portion of the first base, the holding portion comprises a first surface, a second surface and a third surface, the guiding component contacts the first surface and the second surface, the guiding component does not contact the third surface, and an angle formed between the first surface and the third surface is equal to an angle formed between the second surface and the third surface.
